(19) United States
(12) Patent Application Publication
(10) Pub. No.: US 2025/0062560 A1
(43) Pub. Date: Feb. 20, 2025

(54) CONTACT ELEMENT WITH SHAPE MEMORY MATERIAL

(71) Applicant: TE Connectivity Solutions GmbH, Schaffhausen (CH)

(72) Inventors: Uwe SIEGEL, Bensheim (DE); Michael FLOESSER, Bensheim (DE); Mirko KILIAN, Bensheim (DE); Bernd KOSCH, Bensheim (DE)

(21) Appl. No.: 18/805,314

(22) Filed: Aug. 14, 2024

(30) Foreign Application Priority Data
Aug. 15, 2023 (DE) 102023121762.3

(51) Int. Cl. H01R 13/11; H01R 13/03

(52) U.S. Cl. CPC H01R 13/11; H01R 13/03

(57) ABSTRACT

An electrical contact element for mating with a mating contact includes at least one elastically deflectable spring element which has at least one contact point for contacting the mating contact and is designed to generate a contact force acting on the mating contact during operation, at least one section made of a shape memory material being integrated into the at least one contact element, which can be transformed from a first into a second shape depending on the temperature, wherein the at least one contact point in the force-free state of the contact element is located in the first shape of the section made of a shape memory material at a first contact position and in the second shape of the section made of a shape memory material at a second contact position. The contact element is able to reliably hold a mating contact even under difficult environmental conditions, to provide a low contact resistance and to be easily mated with the mating contact.

### CROSS REFERENCE TO RELATED APPLICATIONS

This application claims the benefit of DE Application No. 102023121762.3, filed 15 Aug. 2023, the subject matter of which is herein incorporated by reference in its entirety.

### BACKGROUND OF THE INVENTION

The subject matter herein relates to electrical contact assemblies and a method for automatically securing electrical contact assemblies.

Contact elements are used in electrical plug connectors, for example, to establish an electrical contact together with a mating contact. Contact elements usually have a spring element that generates a contact force acting on the mating contact when contact element and mating contact are plugged together. The contact force is intended on the one hand to fix the mating contact in the socket and on the other hand to ensure a low contact resistance between the mating contact and the spring element and/or the spring element and the socket. For contact elements that are used in an environment with high temperature fluctuations and/or strong vibrations, the contact force should be as high as possible.

However, a high contact force has disadvantages. For example, a high contact force is associated with large insertion forces that have to be overcome when inserting or removing the mating contact. High insertion forces make it difficult to insert and/or remove the mating contact, especially under unfavorable conditions, e.g. in an ergonomically unfavorable position. In addition, high contact forces lead to increased wear of the contact element and/or mating contact due to high material removal.

There is a need for a contact element which is capable of reliably retaining a mating contact even under difficult ambient conditions, which has a low contact resistance and which is easy to mate with the mating contact.

### BRIEF DESCRIPTION OF THE INVENTION

In one embodiment, an electrical contact element is provided for mating with a mating contact. The electrical contact element includes at least one elastically deflectable spring element which has at least one contact point for contacting the mating contact and is designed to generate a contact force acting on the mating contact during operation. The electrical contact element includes at least one section made of a shape memory material being integrated into the at least one contact element, which can be transformed from a first into a second shape depending on the temperature, wherein the at least one contact point in the force-free state of the contact element is located in the first shape of the section made of a shape memory material at a first contact position and in the second shape of the section made of a shape memory material at a second contact position. The contact element is able to reliably hold a mating contact even under difficult environmental conditions, to provide a low contact resistance and to be easily mated with the mating contact.

An electrical contact element that provides two different contact positions depending on the temperature enables the contact force between the contact element and the mating contact to be generated as required. In this way, the contact force and thus the insertion force between the contact element and the mating contact can be kept low during mating, in particular the same as or lower than with mating systems without shape memory material. This makes assembly easier, especially under ergonomically difficult conditions. If the temperature rises during operation of the electrical contact element, which also occurs, for example, under heavy mechanical stress and due to the friction caused by vibrations, the shape memory material is transferred to its second shape. As a result, the contact position of the shape memory material is displaced, which leads to an increase in the contact force between the contact element and the mating contact. This ensures that the mating contact is firmly seated in the contact element during operation. The contact element therefore has the advantage of being easy to install and ensuring that the mating contact is firmly seated during operation exactly when it is needed.

The above electrical contact element can be further improved by the following features, each of which is preferred and can be combined with one another as desired.

The shape memory material can be at least one material from the group of shape memory alloys (e.g. NiTi, NiTiCu, FeMnSi, CuZn, CuZnAl, CuAlNi, ZnAuCu, FeNiAl), shape memory ceramics (e.g. zirconium(IV) oxides, bismuth iron oxides, vanadium(IV) oxide) and/or shape memory polymers (e.g. phase-separated linear (multi-) block copolymers, amorphous polynorbornene, thermally crosslinked poly(ethylene-co-vinyl acetate), crosslinked copolymers of acrylate, caprolactone and glycolic acid).

The shape memory material can have a predetermined changeover temperature, the exceeding of which causes the section of a shape memory material to change from the first shape to the second shape. Preferably, the changeover temperature can be adapted to the application, in particular to the temperatures occurring in the respective contact element at predetermined currents and/or vibrations. Preferably, the at least one section of a shape memory material of the contact element can have its first shape at room temperature.

The section made of a shape memory material can represent only one section or several sections of the contact element that are spaced apart from one another. The section made of a shape memory material can also be a coating. In particular, the coating may be located on the at least one spring element and/or may be an area located between the contact point and a base body of the contact element on which the at least one spring element is located. The area may extend over the entire cross-section or only a part of the cross-section of the contact element.

In one configuration, the contact element can also be made entirely from a shape memory material. For example, the contact element can consist solely of the spring element.

According to another embodiment, at least one section of the at least one section of shape memory material may have a one-way memory effect. In particular, the second shape may be irreversible, such that the first state of the shape memory material cannot be restored after conversion to the second state. Such a configuration has the advantage that a contact element that has been transferred to the second shape of the shape memory material cannot be transferred again—in particular not unintentionally—to the first shape of the shape memory material. This ensures, for example, that the contact element, which is in the second shape, remains dimensionally stable even under the influence of fluctuating operating conditions (e.g. temperature, vibrations, current flow). Furthermore, a contact element of this embodiment offers the possibility of establishing a fixed, in particular non-detachable connection with a second element.

According to a further aspect, at least one section of the at least one section of shape memory material may have a two-way memory effect. As a result of the two-way memory effect, the at least one section of a shape memory material of the contact element can be reversibly deformable between the first shape and the second shape. In particular, this deformation can be reversible depending on the temperature. Due to the reversible transferability between the first shape and the second shape of the section, the contact element can be reused. If the contact element is used together with the mating contact, this connection can be designed to be reversible and detachable without damage.

Furthermore, at least one section can be made of a shape memory material with a one-way memory effect and at least one other section can be made of a shape memory material with a two-way memory effect.

According to another preferred embodiment, the contact element can have a receptacle for inserting the mating contact, and at least one spring element can be moved towards the receptacle in the second shape relative to the first shape. This configuration allows the mating contact to be inserted into the contact element, whereby a mechanical and/or electrical connection can be established between the mating contact and the contact element. Due to the mobility of the spring element towards the receptacle, the contact element can exert a contact force on the mating contact, which improves the fit of the mating contact in the contact element or the stability of the connection in general.

In the second shape of the shape memory material, a clear width of the receptacle can be smaller than in the first shape of the shape memory material. If a mating contact according to this embodiment is inserted into the contact element, the sections of which made of a shape memory material are located in the first shape, the insertion process is facilitated, as the clear width of the receptacle is greater than if the sections made of a shape memory material are located in the second shape.

According to another preferred embodiment, the contact element in the first shape can have an outer dimension that is smaller than in the second shape. Such a contact element is particularly easy to install in the first shape—e.g. if the contact element is to be inserted into a socket—while a tight fit of the contact element can be realized after reaching the second shape.

In the first shape, the contact element can have an internal diameter that is larger than in the second shape. However, the inner diameter of the contact element can also be smaller in the first shape than in the second shape. The inner diameter can, for example, be understood as the smallest distance in the radial direction between two points of the contact element that are spaced apart closest to the longitudinal axis of the contact element.

According to another embodiment, the at least one spring element can be formed by a tongue punched out of the remaining contact element. Such a contact element can be manufactured cost-effectively, particularly as part of an automated production process.

According to a further aspect, the contact element can be designed to deform automatically from the first to the second shape when an electric current flowing through the contact element exceeds a predetermined minimum value. The shape of such a contact element can be easily adjusted by applying an electric current, which enables a controlled control system. Furthermore, depending on the current flow, the contact element can automatically deform into the preferred shape for the respective current flow, which increases performance.

The contact element can also be designed to deform from the second to the first shape if the current flowing through the contact element falls below a predetermined limit value. In this case, the limit value can be smaller or larger than the minimum value. The minimum value and/or the limit value can correspond to a temperature of the contact element, which can be predetermined in particular.

According to another preferred embodiment, the contact element can be a contact element from the following group of contact elements: a radial spring that is bent into a ring; a crown spring; a shielding sleeve; a contact pin; a crimp plug or a crimp socket; a clamp or an insert for a clamp.

The contact element according to this embodiment can be flexibly adapted to different applications and fields of use. For example, the type of contact element can be selected depending on numerous criteria, such as the required contact force, manufacturing costs, assembly effort, mechanical load capacity or availability.

In the case of the coil spring, which is bent into a ring, the entire contact element can represent the elastically deflectable spring element. The contact points for contacting the mating contact can be those points on the radial spring that are furthest inwards in the radial direction.

The crown spring can have spring elements that extend from a ring in the axial direction. In particular, the spring elements can extend in the axial direction between two rings that are opposite each other along the longitudinal direction of the crown spring. Furthermore, there may also be several spring elements distributed in the circumferential direction around a central receptacle. In particular, the spring elements can have a concave or convex shape in the longitudinal direction.

The shielding sleeve can be an essentially cylindrical member on which several spring elements are arranged spaced apart from one another in the circumferential direction. The spring elements can be deflected inwards in the radial direction and/or outwards in the radial direction. Preferably, the spring elements of the shielding sleeve are monolithically formed with the essentially cylindrical body of the shielding sleeve. At least one spring element of the shielding sleeve can also have an area that is curved in the radial direction. In particular, the curvature can be concave or convex.

The spring elements of the contact pin can extend along the longitudinal axis of the contact pin and be curved relative to the longitudinal axis of the contact pin. The curvature is preferably convex, however it can also be concave. The contact pin can have several spring elements which protrude from the contact pin spaced apart from one another along the circumferential direction of the contact pin.

If the contact element is a clamp or an insert for a clamp, the spring elements can be formed by legs or arms that are opposite each other relative to a longitudinal axis of the contact element. The legs or arms can be designed to be elastically deflectable inwards in the radial direction and/or outwards in the radial direction. In particular, the legs or arms can perform a gripping movement directed inwards in the radial direction or outwards in the radial direction when the at least one section of shape memory material is transferred from the first shape to the second shape or from the second shape to the first shape.

According to a further aspect, a contact assembly with a contact element and a mating contact plugged together with the contact element can be provided, wherein a contact force exerted by the contact element on the mating contact can be smaller in the first shape than in the second shape. During operation, different contact forces may be required or preferred between the contact element and the mating contact, e.g. depending on the vibrations, temperatures or currents that occur. As the contact forces exerted in the two shapes of the contact element differ, the contact force can be set as required. As a result, for example, the material load is reduced and durability is increased.

According to another preferred embodiment, a surface area of a contact surface at which the contact element and the mating contact come into contact can be smaller in the first shape than in the second shape. A reduction in the surface area of the contact surface reduces the friction between the contact element and the mating contact when they are moved relative to each other. Such a contact assembly consequently facilitates the alignment of the contact element relative to the mating contact and reduces wear. Furthermore, the surface pressure and thus the material load can be reduced in the second shape, as the contact force is distributed over a larger contact surface than in the first shape.

According to another embodiment, the contact assembly may have a first intended operating state for conducting a current between the contact element and the mating contact and a second intended operating state for conducting a current between the contact element and the mating contact, wherein the contact assembly is in the first operating state when the contact element is in the first shape and is in the second operating state when the contact element is in the second shape.

The intended operating states can be achieved in particular by using the contact assembly or contact element as intended. The intended use is defined, for example, in the Machinery Directive 2006/42/EC. In addition, the intended use of the contact assembly or contact element is clearly and comprehensibly specified in the technical documentation and/or the operating instructions for the contact assembly or contact element based on the legal requirements.

In the first intended operating state, the contact assembly can be fully mated and/or finished. In particular, the contact assembly can be fully functional in the first intended operating state. In the second operating state, the contact force can be increased compared to the first operating state. Furthermore, the contact force in the first operating state can correspond to the contact force of a contact element not equipped with a shape memory material.

According to another preferred embodiment, a set with a plurality of contact elements can be provided, wherein the set can have first contact elements, which have a section made of a shape memory material in a first configuration, and second contact elements, which have a section made of a shape memory material in a second configuration that differs from the first configuration, wherein the first and second contact elements have an identical configuration except for the section made of shape memory material. The differently shaped sections allow the contact elements to be flexibly adapted to different requirements. At the same time, the manufacturing costs for the set of several contact elements are limited, as the contact elements do not differ structurally except for the sections.

The first contact elements can have a different temperature at which the section changes from the first shape to the second shape than the second contact elements.

The at least one section of the shape memory material can be plastically deformed, for example as a tongue bent out of a plane of a sheet metal, as a crimped part (crimp wing) of a crimp connection or as a curved spring. In this case too, the change from the first to the second shape increases the contact force.

According to a further aspect, a method may be provided for automatically securing an electrical contact assembly comprising a contact element and a mating contact mated with the contact element, wherein the contact element may comprise at least one section of shape memory material which automatically deforms from a first shape to a second shape when the temperature increases due to vibrations and/or a current flow between the contact element and the mating contact, wherein in the first shape the contact force exerted by the contact element on the mating contact is lower than in the second shape. Under the influence of vibrations, there is a risk that the mating contact will become detached from the contact element or that the quality of the electrical connection between the mating contact and the contact element will deteriorate. The transfer of the section from the first to the second shape initiated by an increase in temperature during operation can increase the contact force, which tightens the fit of the mating contact in the contact element and thus improves the quality of the electrical connection. Furthermore, unintentional loosening of the connection is prevented.

In the following, the invention is explained in more detail by means of embodiments with reference to the attached figures. Individual features present in the embodiment below may be omitted if, according to the above embodiments, the technical effect associated with this feature is not important. Conversely, a feature described above but not present in an embodiment below can be added to the embodiment if the technical effect associated with this feature is important for a particular application.

### BRIEF DESCRIPTION OF THE DRAWINGS

FIG. 1 is a schematic perspective view of a contact element according to a possible embodiment;

FIG. 2 is a schematic sectional view of the contact element from FIG. 1;

FIG. 3 is a schematic perspective view of a contact element in a possible configuration as a radial spring contact;

FIG. 4 is a schematic perspective view of a contact element in a possible configuration as a crown spring;

FIG. 5 is a schematic perspective view of a contact element in a further possible configuration as a crown spring;

FIG. 6 is a schematic perspective view of a contact element in a possible configuration as a shielding sleeve;

FIG. 7 is a schematic perspective view of a contact element in a possible configuration as a contact pin;

FIG. 8 is a schematic perspective view of a set of several contact elements according to a possible embodiment;

FIG. 9 is a schematic perspective view of a contact element in a possible embodiment as a crimp contact;

FIG. 10 is a schematic perspective view of a contact assembly according to a possible embodiment;

FIG. 11 is a schematic sectional view of the contact assembly from FIG. 10.

### DETAILED DESCRIPTION OF THE INVENTION

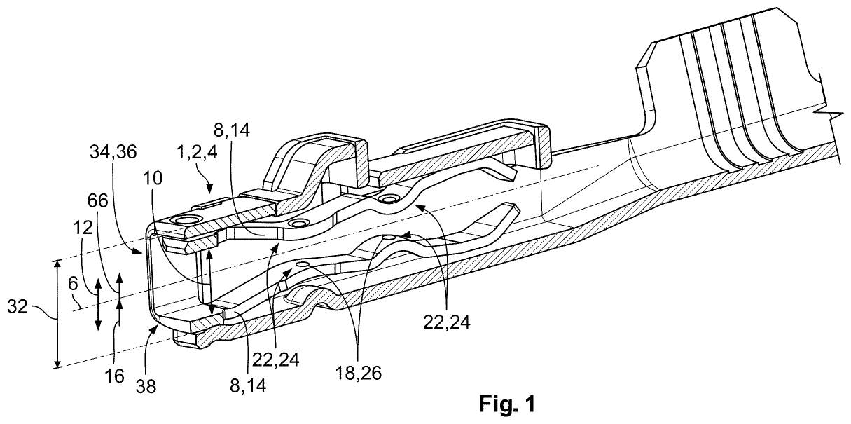

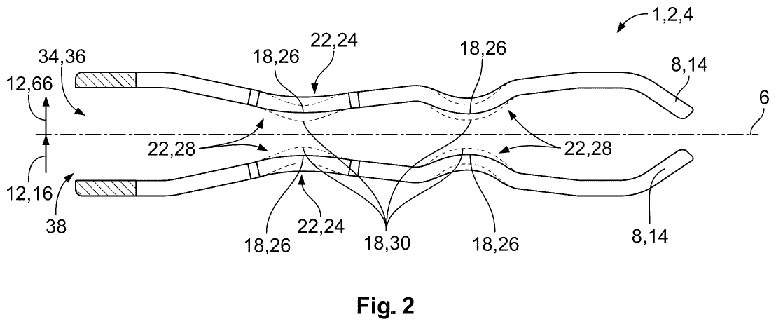

In the following, an electrical contact element 1 is described by way of example with reference to FIG. 1 and FIG. 2.

The electrical contact element 1 shown in FIG. 1 and FIG. 2 is in a force-free state 2. The contact element 1 is designed as a clamp 4, which has two legs 8 arranged symmetrically opposite each other relative to a longitudinal axis 6 of the contact element 1. A distance 10 in a radial direction 12 between the legs 8 changes along the longitudinal axis 6 of the contact element 1. In the embodiment shown, the legs 8 each act as spring elements 14, which can be elastically deflected in the radial direction 12. If the legs 8 or the spring elements 14 are deflected in a radial direction outwards 66, the legs 8 or the spring elements 14 move away from each other, and if the legs 8 or the spring elements 14 are deflected in a radial direction inwards 16, the legs 8 or the spring elements 14 move towards each other.

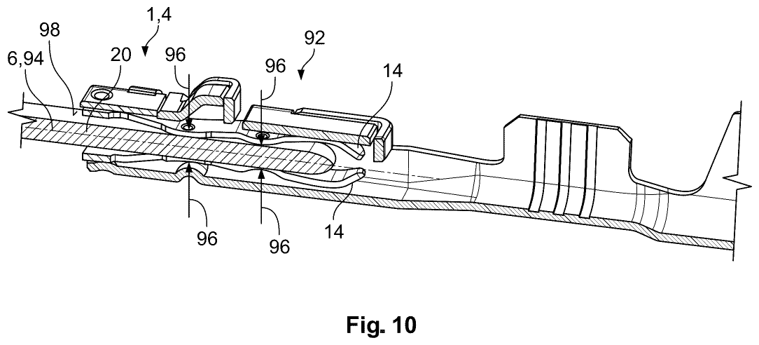

In the embodiment shown, each spring element 14 has contact points 18, which are provided for making contact with a mating contact 20 (see FIG. 10). A total of four contact points 18 are arranged on the contact element 1, which are opposite each other relative to the longitudinal axis 6 of the contact element 1 and project in the radial direction inwards 16.

The contact element 1 also has two sections made of a shape memory material 22. In this context, the shape memory material can comprise at least one material from the group of shape memory alloys, shape memory ceramics and shape memory polymers. In the embodiment shown, the sections 22 are each arranged at a contact point 18. As shown in FIG. 1, the sections of shape memory material 22 are located in a first shape 24, and the contact points 18 are located at a first contact position 26.

Depending on the temperature, the sections 22 can be transferred from the first shape 24 to a second shape 28, which is shown schematically and purely by way of example by a dashed contour in the sectional view shown in FIG. 2. In the second shape 28, the contact points 18 of the contact element 1 are located at a second contact position 30. In the embodiment shown, the contact points 18 in the second shape 28 of the sections 22 are located further inwards in the radial direction 16, that is, closer to the longitudinal axis 6 of the contact element 1, than the contact points 18 in the first shape 24.

According to a possible embodiment, the entire contact element 1 or the entire spring elements 14 can be made of a shape memory material, or the section made of a shape memory material 22 can extend over the entire contact element 1 or the entire spring elements 14. In particular, the spring elements 14 can be elastically deflected in the radial direction inwards 16 when the sections made of shape memory material 22 are transferred from their first shape 24 to their second shape 28. This allows the legs 8 of the clamp 4 to perform a gripping movement in the radial direction inwards 16.

The contact element 1 also has an outer dimension 32. The outer dimension 32 denotes the distance in the radial direction 16 between the points of the spring elements 14 or the legs 8 of the clamp 4 that are furthest away from the longitudinal axis 6 of the contact element 1. In the embodiment shown, the outer dimension 32 of the contact element 1 does not decrease when the contact element 1 is transferred from the first shape 24 to the second shape 28. According to a further embodiment, however, the contact element 1 in the first shape 24 can also have an outer dimension 32 that is smaller or larger than in the second shape 28.

The contact element 1 can also have a receptacle 34. The receptacle 34 can represent an opening 36, which is located at an axial end 38 of the contact element 1. The mating contact 20 (see FIG. 10) can be inserted into or pulled out of the contact element 1 along the longitudinal axis 6 of the contact element 1 via the receptacle 34 or the opening 36.

As shown below, the contact element 1 is not fixed to the configuration shown in FIG. 1 and FIG. 2. Rather, the contact element 1 can be designed, for example, as a radial spring 40 bent to a ring, a crown spring 42, a shielding sleeve 44, a contact pin 46, a crimp plug 48 or a crimp socket 50, a clamp 8, or as an insert 52 for a clamp 8.

These various configurations of the contact elements are described in detail below.

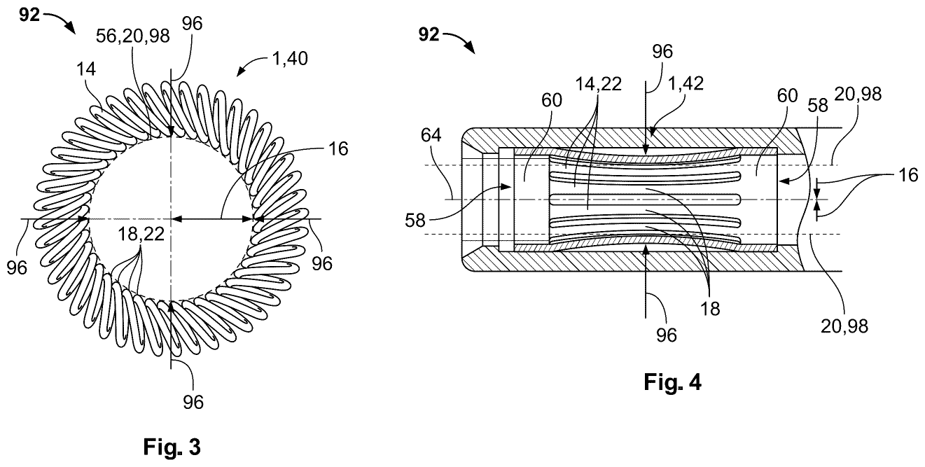

According to an embodiment shown in FIG. 3, the contact element 1 is designed as a radial spring 40, which is bent to a ring or torus. In the embodiment shown, the entire contact element 1 represents the elastically deflectable spring element 14. The contact points 18 for making contact with the mating contact 20 can, for example, be those points of the radial spring 40 that are furthest inwards in the radial direction 16. As shown in FIG. 3, the contact points 18 can be arranged on an inner contour 56 of the radial spring 40. The inner contour 56 is shown schematically as a dashed line in FIG. 3. In the embodiment shown, the sections made of the shape memory material 22 are arranged at the contact points 18. According to a further embodiment, however, the entire radial spring 40 can also be made of the shape memory material or the section 22 can extend over the entire radial spring 40.

In the embodiment shown, a mating contact 20 is inserted into the contact element 1 or the radial spring 40. The mating contact 20 and the contact element 1 or the radial spring 40 form the contact assembly 92. The mating contact 20 is in contact with the contact points 18 of the contact element 1 or the radial spring 40, so that the outer side 98 of the cylindrical mating contact 20 extends along the inner contour 56 of the radial spring 40. The contact element 1 or the radial spring 40 exerts a contact force 96 acting inwards in the radial direction on the outer side 98 of the mating contact 20.

During operation, the sections of a shape memory material 22 are transferred from the first shape 24 to the second shape 28. The transfer can be initiated, for example, by an increase in temperature of the contact element 1 or the radial spring 40, a current flow between the contact element 1 or the radial spring 40 and the mating contact 20 or by vibrations and/or friction between the contact element 1 or the radial spring 40 and the outer side 98 of the mating contact 20.

By transferring the sections made of a shape memory material 22 from the first shape 24 to the second shape 28, the contact element 1 or the radial spring 40 has the tendency to deform in the radial direction inwards 16. Since this deformation is blocked by the mating contact 20, there is an increase in the contact force 96 between the contact element 1 or the radial spring 40 and the outer side 98 of the mating contact 20.

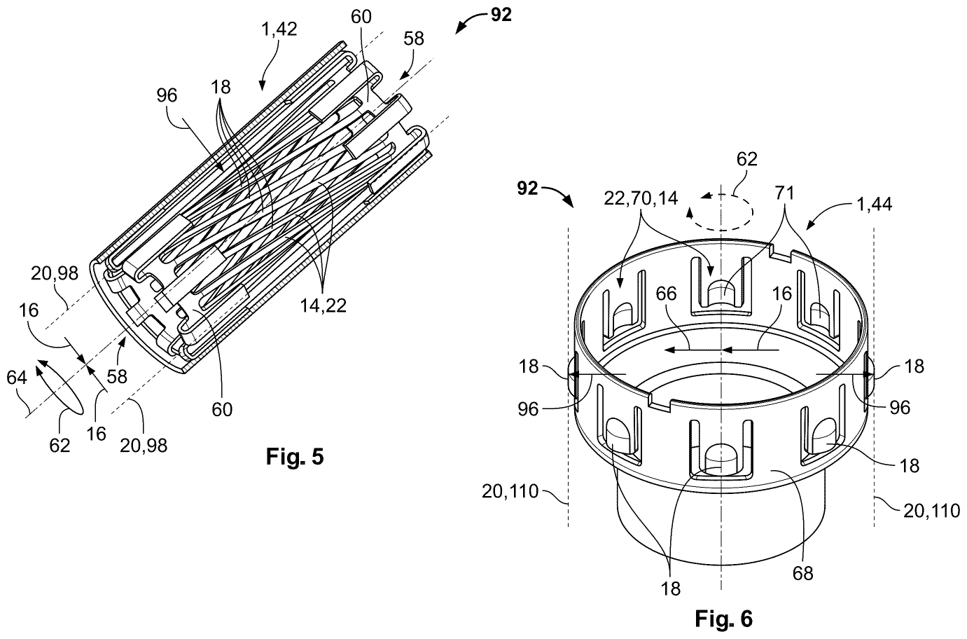

According to the embodiments shown in FIG. 4 and FIG. 5, the contact element 1 can also be designed as a crown spring 42. The crown spring 42 has an essentially cylindrical shape, at the axial ends 58 of which annular sections 60 are arranged. Between the annular sections 60, a plurality of spring elements 14 extend along a longitudinal axis 64 of the crown spring 42, which are arranged next to each other in the circumferential direction 62. In the embodiment shown in FIG. 4, the spring elements 14 of the crown spring 42 are concavely curved relative to the longitudinal axis 64 of the crown spring 42, while in the embodiment shown in FIG. 5, the spring elements 14 of the crown spring 42 extend helically around the longitudinal axis 64 of the crown spring 42. Furthermore, the spring elements 14 of the crown spring 42 can be convexly curved relative to the longitudinal axis 64 of the crown spring 42—at least in sections. In the embodiments shown in FIG. 4 and FIG. 5, the sections of a shape memory material 22 extend over the entire spring elements 14. The spring elements 14 each have a contact point 18, which is located in the center of each spring element 14 with respect to the longitudinal axis 64 of the crown spring 42.

In FIG. 4 and FIG. 5, a contact assembly 92 is shown in each case, which comprises a mating contact 20 inserted in the contact element 1 or in the crown springs 42. The outer side 98 of the mating contact 20 is shown schematically as a dashed line. The mating contact 20 is in contact with the contact points 18 of the contact element 1 or the crown spring 42. The contact element 1 or the crown spring 42 causes a contact force 96 acting in the radial direction inwards 16 on the outer side 98 of the mating contact 20.

In operation, the sections of a shape memory material 22 or the spring elements 14 are transferred from the first shape 24 to the second shape 28. The transfer can be initiated, for example, by an increase in temperature of the contact element 1 or the crown spring 42, a current flow between the contact element 1 or the crown spring 42 and the mating contact 20 or by vibrations and/or friction between the contact element 1 or the crown spring 42 and the outer side 98 of the mating contact 20.

By transferring the sections of a shape memory material 22 from the first shape 24 to the second shape 28, the spring elements 14 have the tendency to deform in the radial direction inwards 16. Since this deformation is blocked by the mating contact 20, there is an increase in the contact force 96 between the contact element 1 or the crown spring 42 and the outer side 98 of the mating contact 20.

As can be seen from FIG. 6, the contact element 1 can be designed as a shielding sleeve 44. The shielding sleeve 44 shown is a substantially cylindrical member on which a plurality of spring elements 14 spaced apart from one another in the circumferential direction 62 are arranged. The spring elements 14 can be deflectable in a radial direction inwards 16 and/or in a radial direction outwards 66. Preferably, the spring elements 14 of the shielding sleeve 44 are formed monolithically with the substantially cylindrical body 68 of the shielding sleeve 44. Thus, in the embodiment shown, the spring elements 14 of the contact element 1 represent tongues 70 which are punched out of the contact element 1 or the shielding sleeve 44, in particular from the body 68 of the shielding sleeve 44. According to another embodiment, the spring elements 14 can also be connected to the shielding sleeve 44 or to the contact element 1 in a form-fit, force-fit or otherwise material-fit manner. At least one spring element 14 of the shielding sleeve 44 can also have a section 71 that is curved in the radial direction. In particular, the curvature can be concave or convex. In the embodiment shown, the contact points 18 of the contact element 1 or the shielding sleeve 44 are arranged on the outer side of the sections 71. Furthermore, the sections made of a shape memory material 22 extend over the entire spring elements 14 or tongues 70.

FIG. 6 further shows a contact assembly 92 comprising a mating contact 20 and a shielding sleeve 44 inserted into the mating contact 20. In operation—in particular under the influence of temperature increases, current flow and vibrations—the sections made of a shape memory material 22 or the spring elements 14 are transferred from the first shape 24 to the second shape 28. As a result, the spring elements 14 have the tendency to deform in the radial direction outwards 66. Since the mating contact 20—indicated by dashed lines—blocks this deformation, the contact force 96 between the contact element 1 or the shield sleeve 44 and an inner side 110 of the mating contact 20 is increased. The fit of the shield sleeve 44 in the mating contact 20 is consequently tighter in the second shape than in the first shape.

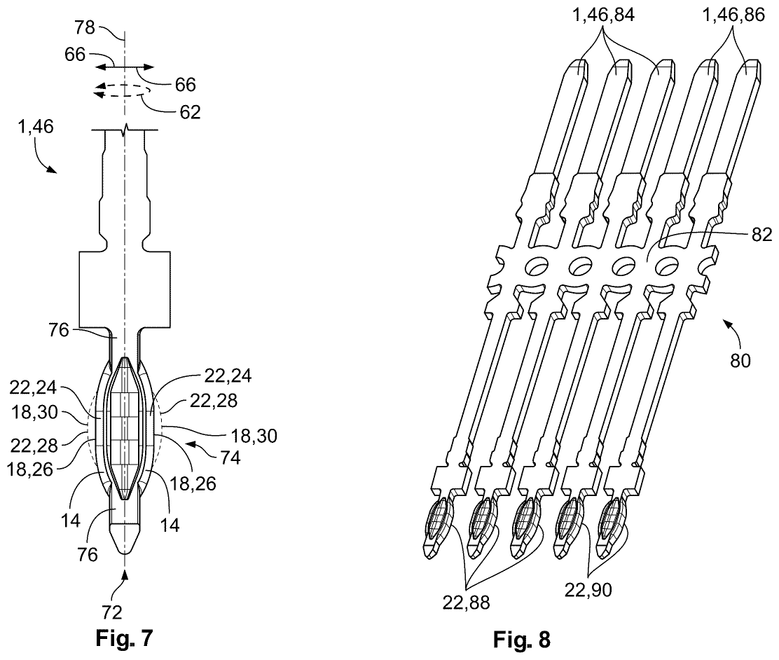

In the embodiment shown in FIG. 7, the contact element 1 is designed as a contact pin 46. The contact pin 46 shown is essentially rod-shaped and has a press-fit section 74 at one axial end 72. The press-fit section 74 has two base portions 76 spaced apart along a longitudinal axis 78 of the contact pin 46, between which several spring elements 14 extend. The spring elements 14 are arranged side by side along the circumferential direction 62 and extend along the longitudinal axis 78 of the contact pin 46. In the embodiment shown, the spring elements 14 are convex relative to the longitudinal axis 78 of the contact pin 46 or curved in the radial direction outwards 66. Furthermore, the spring elements 14 can also be concave or not curved at all.

In the embodiment shown in FIG. 7, the sections made of a shape memory material 22 are those sections of the spring elements 14 that are spaced apart furthest from the longitudinal axis 78 of the contact pin 46 in the radial direction 66. According to further configurations, however, at least one spring element 14 can also be made entirely from a shape memory material or the section made from a shape memory material 22 can extend over at least one entire spring element 14. Furthermore, the entire contact pin 46 can also be made of a shape memory material or the section made of a shape memory material 22 can extend over the entire contact pin 46.

The press-fit section 74 of the contact element 1 or the contact pin 46 can be used, for example, to establish a force-fit connection, in particular a press-fit, between the contact element 1 or the contact pin 46 and a component—for example a PCB. For this purpose, the press-fit section 74 of the contact pin 46 or the contact element 1 can be inserted into the PCB while the sections made of a shape memory material 22 are in the first shape 24. After insertion, the sections 22 can be transferred to the second shape 28. The transfer of the section 22 from the first shape 24 to the second shape 28 can be initiated, for example, by a change in temperature or by the application of an electric current by the contact element 1 or by vibrations.

As a result of the transfer from the first shape 24 to the second shape 28, the spring elements 14 are deformed in the radial direction outwards 66. This results in a displacement of the contact point 18 from the first contact position 26 to the second contact position 30, the second contact position 30 being spaced apart further from the longitudinal axis 6 of the contact element 1 or the longitudinal axis 78 of the contact pin 46 in the radial direction outwards 66 than the first contact position 26. In FIG. 7, the sections 22 in the second shape 28 or the contact points 18 of the spring elements 14 located at the second contact position 30 are shown schematically as dashed lines.

As shown in FIG. 8, a set 80 with a plurality of contact elements 1 can also be provided. In the embodiment shown, the contact elements 1 represent contact pins 46, which are arranged parallel to each other and connected to each other via a bridge 82. However, the contact pins 46 may also be connected to each other in other ways or not at all. The set 80 may further comprise first and second contact elements 84, 86, which have the same configuration except for the sections of shape memory material 22. In particular, the first contact elements 84 may have a plurality of sections 88 fabricated in a first configuration and the second contact elements 86 may have a plurality of sections 90 fabricated in a second configuration.

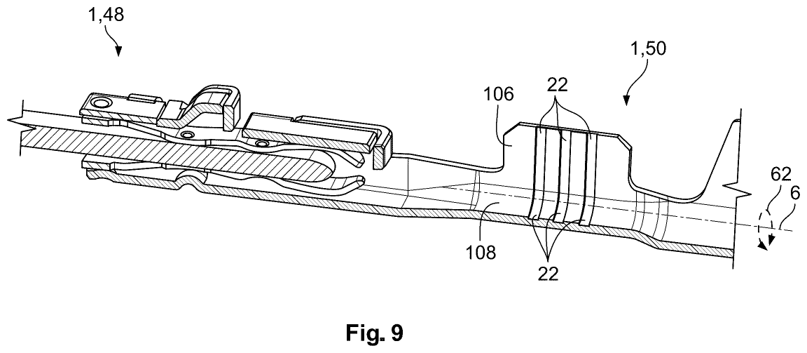

As shown in FIG. 9, the contact element 1 can also be designed as a crimp plug 48 or crimp socket 50. The crimp socket 50 can have a crimp wing 106 that extends tangentially to the essentially cylindrical shape of the crimp socket 50. During the crimping process, the crimp wing 106 can be deformed along the circumferential direction 62 and thus, for example, grip around a mating contact 20 (not shown), e.g. a cable, inserted into the crimp socket. In the embodiment shown, the crimp socket 50 has a plurality of sections of a shape memory material 22 that are spaced apart along the longitudinal axis 6. The sections of a shape memory material 22 extend along the circumferential direction 62 and on an inner side 108 of the crimp socket 50.

During operation—in particular due to temperature increases, current flow and/or vibrations—the sections of a shape memory material 22 are transferred from the first shape 24 to the second shape 28. As a result, the crimp wings 106 of the crimp socket 50 deform and grip around the mating contact 20. Since the mating contact 20 cannot—or in the case that the mating contact 20 is designed as a cable with an elastic sheath, for example—can only partially yield to the deformation, the contact force 96 between the mating contact 20 and the crimp wing is increased.

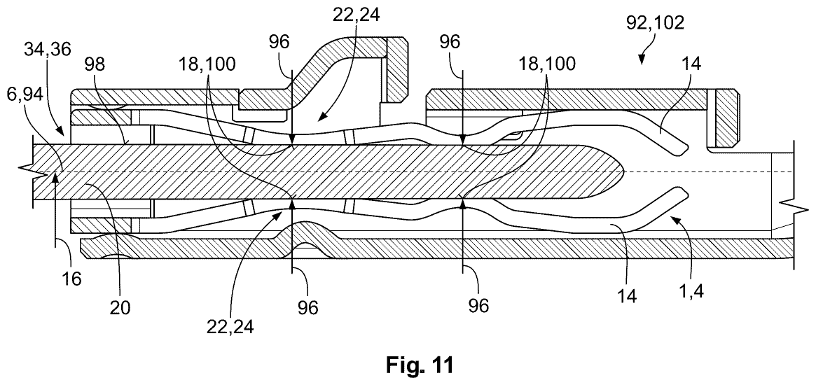

In the following, the structure and function of a contact assembly 92 is described with reference to FIG. 10 and FIG. 11.

The contact assembly 92 comprises a mating contact 20 and a contact element 1, which in the embodiment shown corresponds to the clamp 4 shown in FIG. 1. The mating contact 20 is fully inserted into or mated with the contact element 1. The longitudinal axis 6 of the contact element 1 extends along the longitudinal axis 94 of the mating contact 20 and the mating contact 20 penetrates the receptacle 34 or the opening 36 of the contact element 1. The sections made of a shape memory material 22 of the contact element 1 are located in the first shape 24. The spring elements 14 generate a contact force 96, which acts in the radial direction inwards 16 on an outer side 98 of the mating contact 20. The contact points 18 of the spring elements 14 are in contact with the outer side 98 of the mating contact 20. In particular, the contact element 1 and the mating contact 20 can come into contact at a contact surface 100, as can be clearly seen in FIG. 11.

During operation, an electric current flows between the contact element 1 and the mating contact 20. Furthermore, the contact assembly 1 may be subjected to vibrations and mechanical stresses during operation, which lead to friction between the contact element 1 and the mating contact 20. According to a possible embodiment, the contact assembly 92 may be in a first intended operating state 102 when current is flowing and the contact element 1 is in the first shape 24. The contact assembly 92 shown in FIG. 10 is in the first intended operating state 102.

During operation, in particular in the first intended operating state 102, heat is generated between the mating contact 20 and the contact element 1 as a result of the current flow and/or the vibrations. As a result, the temperature of the contact element 1 rises. After a certain temperature increase or when a transition temperature is reached, at least one section of a shape memory material 22 is transferred from the first shape 24 to the second shape 28 (best seen in FIG. 2).

According to one possible embodiment, the contact element 1 can also deform automatically from the first shape 24 to the second shape 28 if the current flow through the contact assembly 1 exceeds a minimum value. The minimum value can be predetermined.

Due to the transfer of the section 22 from the first shape 24 to the second shape 28, the spring elements 14 have the tendency to be deflected in the radial direction inwards 16. In particular, the contact points 18 attempt to move from the first contact position 26 to the second contact position 30. However, since the contact element 1 is not in the force-free state 2 and a deflection of the spring elements 14 in the radial direction inwards 16 is blocked by the inserted mating contact 20, there is an increase in the contact force 96 between the mating contact 20 and the contact element 1. After the transfer of the contact element 1 into the second shape 28, the contact assembly 92 can in particular be in a second intended state 104. The mating contact 20 can have a tighter fit in the contact element 1 in the second shape 28 than in the first shape 24.

If the sections 22 have a two-way memory effect, the sections 22 can be transferred again from the second shape 28 to the first shape 24. The transfer can be initiated, for example, by a change in temperature, a change in the current flow or as a function of vibrations.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrical contact element for mating with a mating contact, the electrical contact element comprising:
at least one elastically deflectable spring element which has at least one contact point for contacting the mating contact and is designed to generate a contact force acting on the mating contact during operation,
at least one section made of a shape memory material being integrated into the at least one contact element and being transformable from a first shape into a second shape depending on a temperature of the shape memory material,
wherein the at least one contact point in the force-free state of the contact element is located in the first shape of the section made of the shape memory material at a first contact position and in the second shape of the section made of the shape memory material at a second contact position.

2. Electrical contact element according to claim 1, wherein at least one section of the at least one section of the shape memory material has a one-way memory effect.

3. Electrical contact element according to claim 1, wherein at least one section of the at least one section of the shape memory material has a two-way memory effect.

4. Electrical contact element according to claim 1, wherein the contact element has a receptacle for inserting the mating contact, and at least one spring element in the second shape is moved towards the receptacle relative to the first shape.

5. Electrical contact element according to claim 1, wherein the contact element has an external dimension in the first shape which is smaller than in the second shape.

6. Electrical contact element according to claim 1, wherein the at least one spring element is formed by a tongue punched out of the remaining contact element.

7. Electrical contact element according to claim 1, wherein the contact element is configured to deform automatically from the first shape to the second shape when an electric current flowing through the contact element exceeds a predetermined minimum value.

8. Electrical contact element according to claim 1, wherein the contact element is a contact element from the following group of contact elements:
a radial spring bent into a ring;
a crown spring;
a shielding sleeve;
a contact pin;
a crimp plug;
a crimp socket;
a clamp;
an insert for a clamp.

9. Contact assembly comprising:
a contact element and a mating contact mated with the contact element, the contact element comprising:
at least one elastically deflectable spring element which has at least one contact point for contacting the mating contact and is designed to generate a contact force acting on the mating contact during operation,
at least one section made of a shape memory material being integrated into the at least one contact element and being transformable from a first shape into a second shape depending on a temperature of the shape memory material,
wherein the at least one contact point in the force-free state of the contact element is located in the first shape of the section made of the shape memory material at a first contact position and in the second shape of the section made of the shape memory material at a second contact position,
wherein a contact force exerted by the contact element on the mating contact is smaller in the first shape than in the second shape.

10. Contact assembly according to claim 9, wherein in the first shape an area of a contact surface, at which the contact element and the mating contact come into contact, is smaller than in the second shape.

11. Contact assembly according to claim 9, wherein the contact assembly has a first intended operating state for conducting a current between the contact element and the mating contact and a second intended operating state for conducting a current between the contact element and the mating contact, wherein the contact assembly is in the first operating state when the contact element is in the first shape and is in the second operating state when the contact element is in the second shape.

12. Contact assembly according to claim 9, wherein at least one section of the at least one section of the shape memory material has a one-way memory effect.

13. Contact assembly according to claim 9, wherein at least one section of the at least one section of the shape memory material has a two-way memory effect.

14. Contact assembly according to claim 9, wherein the contact element has a receptacle for inserting the mating contact, and at least one spring element in the second shape is moved towards the receptacle relative to the first shape.

15. Contact assembly according to claim 9, wherein the contact element has an external dimension in the first shape which is smaller than in the second shape.

16. Contact assembly according to claim 9, wherein the at least one spring element is formed by a tongue punched out of the remaining contact element.

17. Contact assembly according to claim 9, wherein the contact element is configured to deform automatically from the first shape to the second shape when an electric current flowing through the contact element exceeds a predetermined minimum value.

18. Set comprising:
a plurality of contact elements, each contact element comprising:
a contact element and a mating contact mated with the contact element, the contact element comprising:
at least one elastically deflectable spring element which has at least one contact point for contacting the mating contact and is designed to generate a contact force acting on the mating contact during operation,
at least one section made of a shape memory material being integrated into the at least one contact element and being transformable from a first shape into a second shape depending on a temperature of the shape memory material,
wherein the at least one contact point in the force-free state of the contact element is located in the first shape of the section made of the shape memory material at a first contact position and in the second shape of the section made of the shape memory material at a second contact position,
wherein the set comprises first contact elements of the contact elements having a section made of shape memory material in a first configuration and second contact elements of the contact elements having a section made of shape memory material in a second configuration different from the first configuration,
wherein the first contact elements and the second contact elements are of identical design except for the section of shape memory material.

19. Method for automatically securing an electrical contact assembly, which has a contact element and a mating contact mated with the contact element, wherein the contact element has at least one section made of a shape memory material, the method comprising:
deforming automatically the contact element from a first shape into a second shape when a temperature of the shape memory material increases due to at least one of vibrations and/or a current flow between the contact element and the mating contact,
wherein the contact force exerted by the contact element on the mating contact is lower in the first shape than in the second shape.
